(19) United States
(12) Patent Application Publication
(10) Pub. No.: US 2026/0307006 A1
(43) Pub. Date: Oct. 8, 2026

(54) ABATEMENT OF EFFLUENT CONTAINING AMMONIUM CHLORIDE

(71) Applicant: Applied Materials, Inc, Santa Clara, CA (US)

(72) Inventors: Sue-Ann Yow, Mesa, AZ (US); Andrew Nguyen, Gilbert, AZ (US)

(73) Assignee: Applied Materials, Inc., Santa Clara, CA (US)

(21) Appl. No.: 19/169,519

(22) Filed: Apr. 3, 2025

(51) Int. Cl. B01D 53/68; B01D 53/00

(52) U.S. Cl. CPC B01D 53/68; B01D 53/005; B01D 2257/204; B01D 2258/0216

(57) ABSTRACT

An effluent abatement system includes an exhaust pump connected to a semiconductor device processing apparatus, an abatement foreline connecting the exhaust pump to an abatement apparatus, the abatement foreline having an interior surface and an overall length extending between the exhaust pump and the abatement apparatus, the abatement apparatus comprising a combustor and an abatement foreline connector having an interior surface and disposed between and connecting the abatement foreline and the combustor. The system includes a trace heater along the overall length of the abatement foreline and a polytetrafluoroethylene (PTFE) coating on the interior surface of the abatement foreline for a portion of the overall length of the abatement foreline leading into the abatement foreline connector. Methods of abating effluent including ammonium chloride vapor include utilizing the system.

### TECHNICAL FIELD

Embodiments of the disclosure generally relate to abatement of effluent generated by semiconductor processing equipment. More particularly, embodiments of the present disclosure relate to apparatus and methods for abating ammonium chloride present in the effluent of semiconductor processing equipment.

### BACKGROUND

Effluent produced during semiconductor device manufacturing processes includes many compounds which must be abated or treated before disposal, due to regulatory requirements and environmental and safety concerns. One compound that is present in semiconductor manufacturing effluent from semiconductor processing chambers such as chemical vapor deposition and atomic layer deposition chambers is ammonium chloride (NH₄Cl).

In a conventional abatement system as shown in FIG. 1, effluent gases from a semiconductor device processing chamber 40 are conveyed from the semiconductor device processing chamber 40 via an exhaust line 51 connected to an exhaust pump 52 to an abatement apparatus 60. The abatement apparatus 60 may include a combustor 62, which may include an abatement foreline connector 65 and a combustor 66. Some abatement systems may include an optional cold trap 55 connected to the exhaust pump 52 by a cold trap line 53, which is cooled trap that condenses and traps certain effluent species. Effluent flows through the exhaust pump 52 to an abatement foreline 70, which in some embodiments is heated. In or more embodiments, the abatement foreline 70 is heated by a trace heater 72. Treated gas 82 is exhausted from the abatement apparatus 60.

Ammonium chloride has a tendency to condense into solids and clog the abatement foreline 70 in a length 71L leading into and adjacent to the abatement foreline connector 65 that connects the abatement foreline 70 to the combustor 62. Accordingly, there is a need for apparatus and methods that effectively abate effluent containing ammonium chloride without clogging upstream of the combustor.

One or more embodiments of the disclosure pertain to an effluent abatement system configured to abate effluent containing ammonium chloride gas comprising an exhaust pump connected to a semiconductor device processing apparatus by an exhaust line; an abatement foreline connecting the exhaust pump to an abatement apparatus, the abatement foreline having an interior surface and an overall length extending between the exhaust pump and the abatement apparatus, the abatement apparatus comprising a combustor and an abatement foreline connector having an interior surface and disposed between and connecting the abatement foreline and the combustor; a trace heater along the overall length of the abatement foreline; and a polytetrafluoroethylene (PTFE) coating on the interior surface of the abatement foreline for a portion of the overall length of the abatement foreline leading into the abatement foreline connector.

Another aspect of the disclosure pertains to a method of preventing an effluent abatement system from clogging during the abatement of gases emanating from a semiconductor device processing chamber and containing ammonium chloride vapor, the method comprising: heating an abatement foreline extending between an exhaust pump connected to the semiconductor device processing chamber and an abatement apparatus; coating a portion of the abatement foreline leading into the abatement apparatus comprising a combustor with a polytetrafluoroethylene (PTFE) coating; and coating an abatement foreline connector disposed between the abatement foreline and the combustor with the polytetrafluoroethylene (PTFE) coating

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of the present disclosure and are therefore not to be considered limiting of its scope, for the disclosure may admit to other equally effective embodiments.

FIG. 1 depicts a schematic diagram of an abatement system according to the prior art;

FIG. 2 depicts a schematic diagram of an abatement system according to one or more embodiments of the disclosure; and

FIG. 3 illustrates a flowchart of a method of abating effluent containing ammonium chloride according to one or more embodiments of the disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Before describing several exemplary embodiments of the disclosure, it is to be understood that the disclosure is not limited to the details of construction or process steps set forth in the following description. The disclosure is capable of other embodiments and of being practiced or being carried out in various ways.

The term "about" as used herein means approximately or nearly and in the context of a numerical value or range set forth means a variation of ±2%, ±1%, ±0.5%, or ±0.1%.

Spatially relative terms, such as "beneath," "below," "lower," "above," "upper" and the like, may be used herein for ease of description to describe one element or feature's relationship to another element(s) or feature(s) as illustrated in the Figures. It will be understood that the spatially relative terms are intended to encompass different orientations of a device in use or operation in addition to the orientation depicted in the figures. For example, if the device in the Figures is turned over, elements described as "below" or "beneath" other elements or features would then be oriented "above" the other elements or features. Thus, the exemplary term "below" may encompass both an orientation of above and below. The device may be otherwise oriented (rotated 90 degrees or at other orientations) and the spatially relative descriptors used herein interpreted accordingly.

The use of the terms "a" and "an" and "the" and similar referents in the context of describing the materials and methods discussed herein (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., "such as") provided herein, is intended merely to better describe the materials and methods and does not pose a limitation on the scope unless otherwise claimed. No language in the specification should be construed as indicating any non-claimed element as essential to the practice of the disclosed materials and methods.

Reference throughout this specification to "one embodiment," "certain embodiments," "one or more embodiments" or "an embodiment" means that a particular feature, structure, material, or characteristic described in connection with the embodiment is included in at least one embodiment of the disclosure. Thus, the appearances of the phrases such as "in one or more embodiments," "in certain embodiments," "in one embodiment" or "in an embodiment" in various places throughout this specification are not necessarily referring to the same embodiment of the disclosure. Furthermore, the particular features, structures, materials, or characteristics may be combined in any suitable manner in one or more embodiments.

As used in this specification and the appended claims, the terms "precursor", "reactant", "reactive gas" and the like are used interchangeably to refer to any gaseous species that can react with the substrate surface.

Embodiments of the disclosure advantageously provide effective approaches to reduce clogging in an abatement apparatus configured to abate effluent from a semiconductor processing chamber containing ammonium chloride. Apparatus and methods are provided that prevent and avoid condensation of ammonium chloride to a solid and subsequent clogging of the abatement foreline at or near the abatement foreline connector connected directly to the combustor.

Ammonium chloride is an ammonium salt of hydrogen chloride that forms when chlorine atoms react with ammonia (NH₃). A non-limiting example of a process that produces ammonium chloride is the reaction of silicon tetrachloride (SiCl₄) and ammonia (NH₃) precursors in a chemical vapor deposition (CVD) process to produce silicon nitride (Si₃N₄). During the reaction of the two precursors, ammonium chloride vapor is formed as a byproduct that must be removed by an abatement apparatus in an effluent stream produced by a processing chamber. However, as discussed above, a particularly pernicious problem is the formation of solids immediately upstream from the combustor of the abatement system. It was determined that due to the low vapor pressure of ammonium chloride vapor, the ammonium chloride in vapor form is readily condensed into solid ammonium chloride, causing the solid ammonium chloride to clog the abatement foreline immediately ahead of the abatement foreline connector that connects the abatement foreline to the combustor.

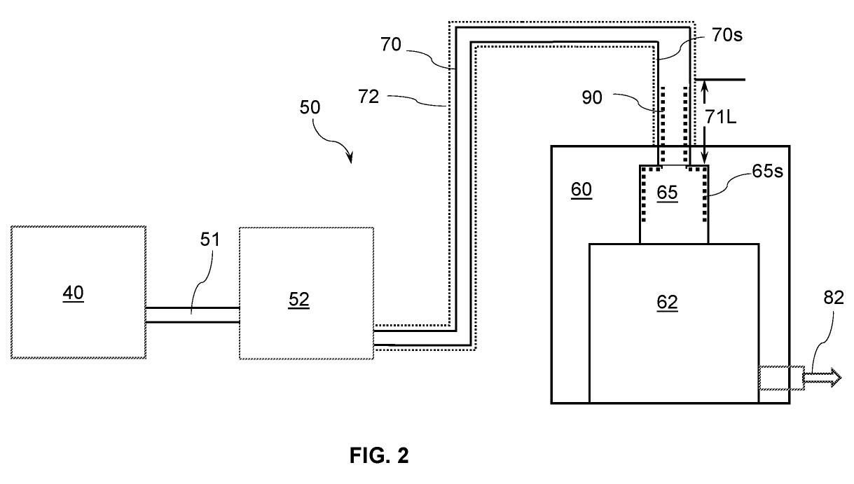

FIG. 2 depicts an embodiment of an abatement system configured to abate effluent gases emanating from a semiconductor device processing chamber 40, which effluent gases are conveyed from the semiconductor device processing chamber 40 via an exhaust line 51 by an exhaust pump 52 to an abatement apparatus 60. An abatement foreline 70 places the exhaust pump 52 in fluid communication with the abatement apparatus 60. The exhaust line 51 connected to the exhaust pump 52 and the semiconductor device processing chamber 40 places the exhaust pump 52 in fluid communication with the semiconductor device processing chamber 40. The exhaust pump 52 according to one or more embodiments comprises a vacuum pump or other suitable pump to remove gaseous effluent through the exhaust line 51 from the semiconductor device processing chamber 40.

In one or more embodiments, the effluent gases comprise ammonium chloride vapor. The abatement apparatus 60 includes a combustor 62, which includes an abatement foreline connector 65 and a combustor 66. The abatement foreline connector 65 is disposed between the abatement foreline 70 and the combustor 66. In the embodiment shown, there is no cold trap as part of the abatement system 50, and the exhaust pump 52 is directly connected to the abatement foreline 70. There is no intervening cold trap between the semiconductor device processing chamber 40 and the abatement apparatus 60. Effluent gases from the semiconductor device processing chamber 40 flow through the exhaust pump 52 to the abatement foreline 70, which may be heated by a trace heater 72. The trace heater 72 according to one or more embodiments includes an electrical heating element (e.g., one or more wires, cables, heat tapes, etc.) connected to an electrical power source (not shown). The trace heater 72 according to one or more embodiments is flexible and configured to wrap around the abatement foreline 70 and conform to the shape of the abatement foreline 70, which is generally in the shape of a cylindrical or tubular conduit according to one or more embodiments. system used to maintain and/or raise the temperature of pipes and vessels using heat tracing cables. In some embodiments, the trace heater 72 further comprises thermal insulation to retain heat losses from the abatement foreline 70. Heat generated by the electrical heating element maintains the temperature of the abatement foreline 70at a temperature that prevents the ammonium chloride vapor from condensing to a solid and clogging the abatement foreline 70 in a length in a range of about 1 to 2 feet from the abatement foreline connector. In some embodiments, the temperature to prevent condensation is in a range of from 130 °C to 170 °C, for example 130 °C to 165 °C or 130 °C to 160 °C. In one or more embodiments, the abatement foreline 70 has a diameter in a range of from 3 to 10 inches, for example 4 to 6 inches.

Treated gas 82 is exhausted from the abatement apparatus 60. According to one or more embodiments, the combustor 62 of the abatement apparatus combustor comprises a plasma torch or another flame-based device, such as an inwardly fired foraminous burner, which decomposes effluent gases in the effluent gas stream produced by the semiconductor device processing chamber 40, which according to one or more embodiment is a vapor deposition processing chamber. The vapor deposition processing chamber according to one or more embodiments is configured to deposit films by chemical vapor deposition or atomic layer deposition.

It was determined that higher flow rates of effluent gas containing ammonium chloride and higher relative humidity caused deposition of ammonium chloride in solid form on the interior surface 70s of the abatement foreline 70, particularly along a length 71L leading into the abatement foreline connector 65. The length 71L leading into the abatement foreline connector 65 is a portion of the overall length of the abatement foreline 70 between the exhaust pump 52 and the abatement apparatus 60. The length 71L leading into the abatement foreline connector 65 is in a range of from 1 to 4 feet, 1 to 3 feet or 1 to 2 feet upstream from the abatement foreline connector 65. The abatement foreline 70 comprises a metal material, which in some embodiments is stainless steel. In one or more embodiments, the abatement foreline 70 has an overall length extending between the exhaust pump and the abatement apparatus 60 in a range of 5 to 10 feet. In the last 1-4 feet, 1 to 3 feet or 1 to 2 feet, the abatement foreline 70 has a reduced diameter that may be reduced by about 50% of the diameter along the length of the foreline exiting the exhaust pump 52. Fore example, the diameter may be reduced from 4 inches in diameter to 2 inches in diameter. A nitrogen purge can be used to try to purge the abatement foreline 70, however, this process can consume large quantities of nitrogen, increasing the cost of the abatement process.

Advantageously, according to one or more embodiments, the interior surface 70s of the abatement foreline 70 along the length 71L, for example 1-2 feet, 1-3 feet or 1-4 feet upstream from the abatement foreline connector 65 is coated with polytetrafluoroethylene (PTFE) coating 90, which is a synthetic fluoropolymer of tetrafluoroethylene. In one or more embodiments, at least a portion of an interior surface 65s the abatement foreline connector 65 is coated with a polytetrafluoroethylene (PTFE) coating. In one or more embodiments, at least 50% the interior surface 65s of the abatement foreline connector 65 is coated with the polytetrafluoroethylene (PTFE) coating. The abatement foreline connector 65 according to one or more embodiments, comprises a threaded coupling and/or a valve.

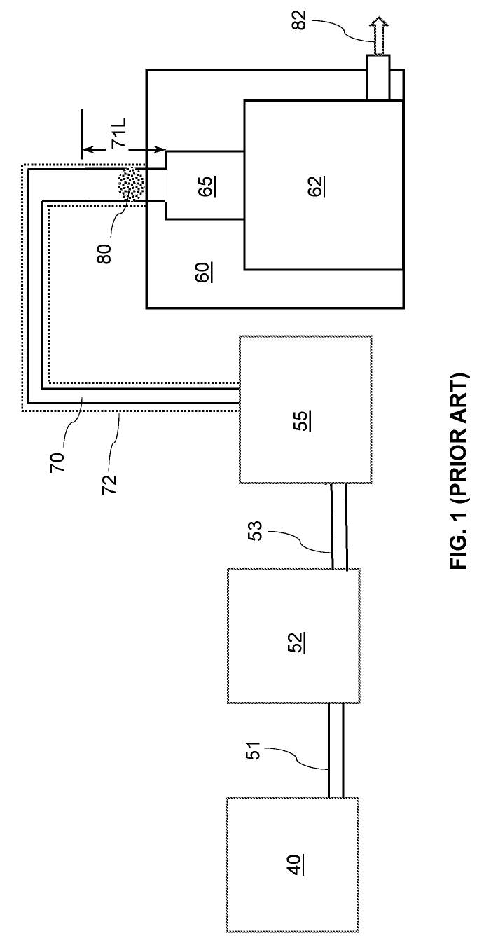

In one or more embodiments, the polytetrafluoroethylene coating 90 has a thickness in a range of from 5 to 50 mils (0.127-1.27 mm), 5-40 mils (0.127-1.016 mm), 5-30 mils (0.127-0.762 mm), 5-20 mils (0.127-0.508 mm), (10-50 mils (0.254-1.27 mm), 10-40 mils (0.254-1.016 mm), 10-30 mils (0.254-0.762 mm) or 10-20 mils (0.254-0.508 mm). Advantageously, by maintaining the temperature at a high enough temperature with the trace heater 72 combined with the polytetrafluoroethylene (PTFE) coating 90, deposition of solid ammonium chloride and clogging of the abatement foreline 70 along the length 71L and at the abatement foreline connector 65 is avoided. It is believed that the polytetrafluoroethylene (PTFE) coating causes a weakened solid to liquid bond between solid ammonium chloride and moisture on the interior surface 70s of the abatement foreline 70. The polytetrafluoroethylene (PTFE) coating also prevents agglomeration of ammonium chloride solid particles, preventing clogging of the abatement foreline 70 as shown in FIG. 1.

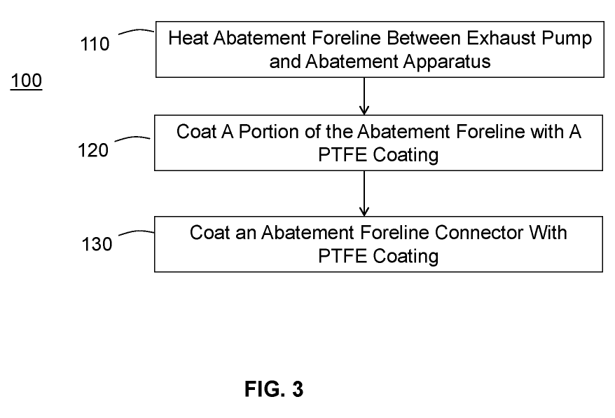

One or more additional embodiments of the present disclosure comprise a method of preventing an effluent abatement system from clogging during the abatement of gases emanating from a semiconductor device processing chamber and containing ammonium chloride vapor. Referring to FIG. 3, the method 100 comprises at 110 heating an abatement foreline extending between an exhaust pump connected to the semiconductor device processing chamber and an abatement apparatus. The method further comprises at 120 coating a portion of the abatement foreline leading into the abatement apparatus comprising a combustor with a polytetrafluoroethylene (PTFE) coating. The method further comprises at 130 coating an abatement foreline connector disposed between the abatement foreline and the combustor with the polytetrafluoroethylene (PTFE) coating.

In one or more embodiments, the polytetrafluoroethylene (PTFE) coating has a thickness in a range of 5-40 mils (0.127-1.016 mm), 5-30 mils (0.127-0.762 mm), or 5-20 mils (0.127-0.508 mm). In some embodiments, the polytetrafluoroethylene (PTFE) coating prevents agglomeration of ammonium chloride solid particles, preventing clogging of the abatement foreline 70. In one or more embodiments, the portion of the foreline coated with the polytetrafluoroethylene (PTFE) coating is in a range of 1-2 feet upstream from the abatement foreline connector 65.

In one or more embodiments, the polytetrafluoroethylene (PTFE) coating prevents clogging of the abatement foreline adjacent to the abatement foreline connector.

Although the disclosure herein has been described with reference to particular embodiments, those skilled in the art will understand that the embodiments described are merely illustrative of the principles and applications of the present disclosure. It will be apparent to those skilled in the art that various modifications and variations can be made to the method and apparatus of the present disclosure without departing from the spirit and scope of the disclosure. Thus, the present disclosure can include modifications and variations that are within the scope of the appended claims and their equivalents.

What is claimed is:

1. An effluent abatement system configured to abate effluent containing ammonium chloride gas comprising:
an exhaust pump connected to a semiconductor device processing apparatus by an exhaust line;
an abatement foreline connecting the exhaust pump to an abatement apparatus, the abatement foreline having an interior surface and an overall length extending between the exhaust pump and the abatement apparatus, the abatement apparatus comprising a combustor and an abatement foreline connector having an interior surface and disposed between and connecting the abatement foreline and the combustor;
a trace heater along the overall length of the abatement foreline; and
a polytetrafluoroethylene (PTFE) coating on the interior surface of the abatement foreline for a portion of the overall length of the abatement foreline leading into the abatement foreline connector.

2. The effluent abatement system of claim 1, wherein the trace heater comprises an electrical heating element.

3. The effluent abatement system of claim 2, wherein the trace heater comprises insulation.

4. The effluent abatement system of claim 2, wherein the portion of the overall length of the abatement foreline leading into the abatement foreline connector has a length in a range of 1 to 4 feet.

5. The effluent abatement system of claim 2, wherein the portion of the overall length of the abatement foreline leading into the abatement foreline connector has a length in a range of 1 to 3 feet.

6. The effluent abatement system of claim 2, wherein the portion of the overall length of the abatement foreline leading into the abatement foreline connector has a length in a range of 1 to 2 feet.

7. The effluent abatement system of claim 6, wherein a portion of the interior surface of the foreline connector comprises the polytetrafluoroethylene (PTFE) coating.

8. The effluent abatement system of claim 6, at least 50% of the interior surface of the foreline connector is coated with the polytetrafluoroethylene (PTFE) coating.

9. The effluent abatement system of claim 6, wherein the polytetrafluoroethylene (PTFE) coating has a thickness in a range of 5-40 mils (0.127-1.016 mm).

10. The effluent abatement system of claim 6, wherein the polytetrafluoroethylene (PTFE) coating has a thickness in a range of 5-30 mils (0.127-0.762 mm).

11. The effluent abatement system of claim 6, wherein the polytetrafluoroethylene (PTFE) coating has a thickness in a range of 5-20 mils (0.127-0.508 mm).

12. The effluent abatement system of claim 11, wherein the polytetrafluoroethylene (PTFE) coating covers at least 50% of the inside surface of the abatement foreline connector.

13. A method of preventing an effluent abatement system from clogging during the abatement of gases emanating from a semiconductor device processing chamber and containing ammonium chloride vapor, the method comprising:
heating an abatement foreline extending between an exhaust pump connected to the semiconductor device processing chamber and an abatement apparatus;
coating a portion of the abatement foreline leading into the abatement apparatus comprising a combustor with a polytetrafluoroethylene (PTFE) coating; and
coating an abatement foreline connector disposed between the abatement foreline and the combustor with the polytetrafluoroethylene (PTFE) coating.

14. The method of claim 13, wherein the polytetrafluoroethylene (PTFE) coating has a thickness in a range of 5-40 mils (0.127-1.016 mm).

15. The method of claim 14, wherein the polytetrafluoroethylene (PTFE) coating has a thickness in a range of 5-30 mils (0.127-0.762 mm).

16. The method of claim 15, wherein the polytetrafluoroethylene (PTFE) coating has a thickness in a range of 5-20 mils (0.127-0.508 mm).

17. The method of claim 16, wherein the polytetrafluoroethylene (PTFE) coating prevents agglomeration of ammonium chloride solid particles, preventing clogging of the abatement foreline 70.

18. The method of claim 17, wherein the portion of the foreline coated with the polytetrafluoroethylene (PTFE) coating is in a range of 1-2 feet upstream from the abatement foreline connector.

19. The method of claim 18, wherein the polytetrafluoroethylene (PTFE) coating prevents clogging of the abatement foreline adjacent to the abatement foreline connector.
